(19) United States
(12) Patent Application Publication
(10) Pub. No.: US 2006/0109644 A1
(43) Pub. Date: May 25, 2006

(54) Liquid illuminator

(76) Inventors: Ralph E. Saucier SR., Buford, GA (US); Dave Anderson, Suwawee, GA (US)

Correspondence Address: RALPH E. SAUCIER, 1927 PIERCE WAY, BUFORD, GA, 30519, US

(21) Appl. No.: 10/991,904

(22) Filed: Nov. 19, 2004

(51) Int. Cl. F21V 33/00

(52) U.S. Cl. 362/101; 362/800; 362/154; 362/155; 362/276

(57) ABSTRACT

The illuminating liquid is the first liquid illuminator that can fit on any standard sports events, or business logo poly bottle and does not require the owner to purchase a special container to advertise his logo. The inventor has intended the patent to be only for the bottom part of the Liquid Illuminator. Using an LED rather than a light as other inventions, the illumination is brighter and will light up a greater variation of liquids. The advertiser logo needs to be silk screened on the poly bottle and does not have to be applied in any other manner. The illuminating of the liquid with the switch in conjunction with the battery and LED illuminates the image or logo on the bottle.

### PURPOSE

The purpose of the Liquid Illuminator is to give a sports bottle, or a translucent liquid container the ability to glow when the liquid is inserted in the poly material container. The liquid can be any liquid that is clear or a color that has some transparent values to it. The functioning is such that liquid can be disposed of by drinking the fluid and then replenishing it. The container, being of a poly transparent material of any color that the consumer or customer desires, will reflect the light and glow when the switch is activated on the container. The further purpose of the Liquid Illuminator is to have a product that will excite the consumer at entertainment parks, sports events, concerts or any other event which a crowd will be drawn to. The Liquid Illuminator will also be a product that will create great promotional excitement that any restaurant chain or business will use to show off their liquid products or their logo which will be screen printed on the surface of the poly bottle.

### BACKGROUND OF THE INVENTION

The invention is designed to be used with a variety of sports events and business advertising poly bottles. It is meant to be able to be made in many different sites to be able to fit any size poly bottles. There are other patent (U.S. Pat. No. 6,254,247 to Carson) which illuminates the bottle, but do not specify a silk screen logo. It specifies illuminating a holographic image silk screened on a film of material and then slipped over the bottle. In the Carson patent the bottle and the illuminating mechanism are fabricated as one unit. The invention proposed in this application is made a separate unit to fit any poly bottle. (U.S. Pat. No. 6,520,657 to DeNicola) is an illumination device that operates on pressure, has a short life, is a chemiluminescent illuminating, and as stated operates on applying pressure. (U.S. Pat. No. 6,786,614 to Clarrocchi Jr.) is an illuminating patent device that needs an external power and is placed inside of a beverage container. (U.S. Pat. No. 6,676,269 to Dorney) is a glow cup with an chemiluminescent fluid placed between two cups to create a glow in the fluid. It operates on no power source.

### Operating the Liquid Illuminator

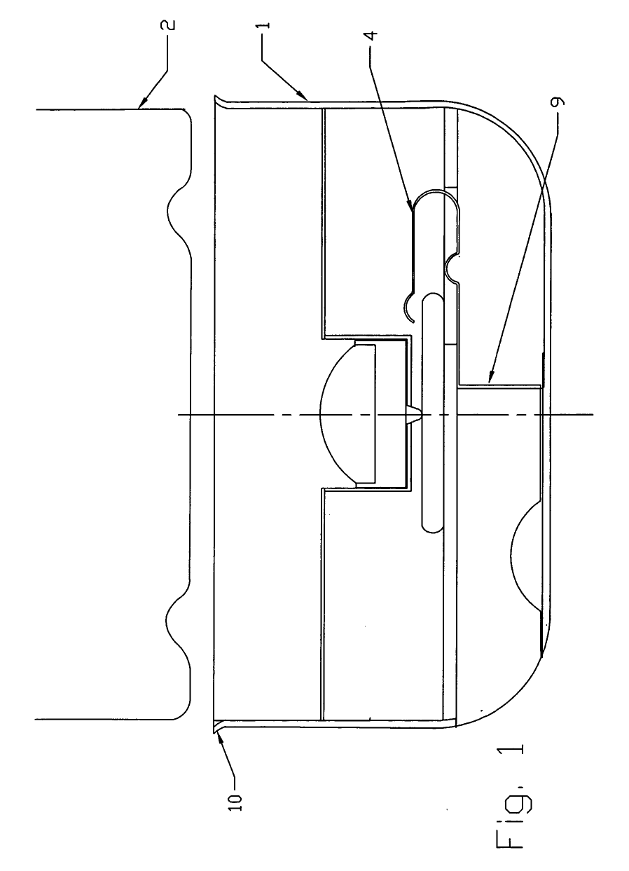

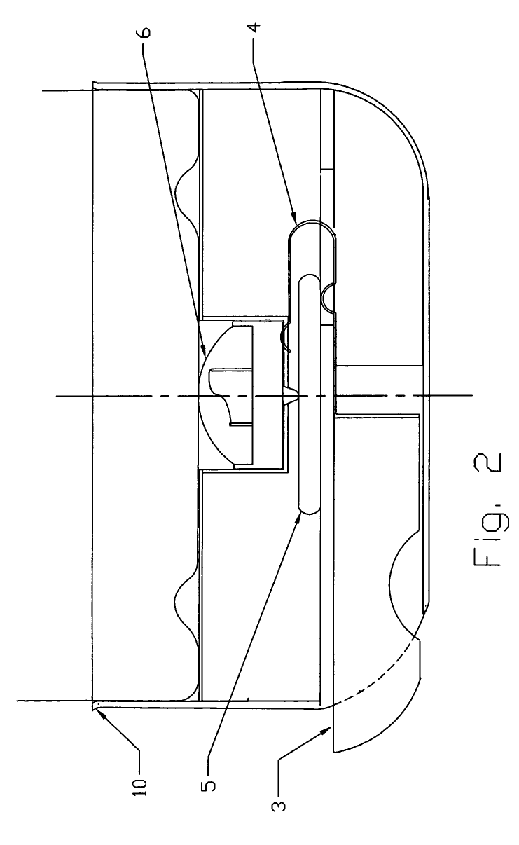

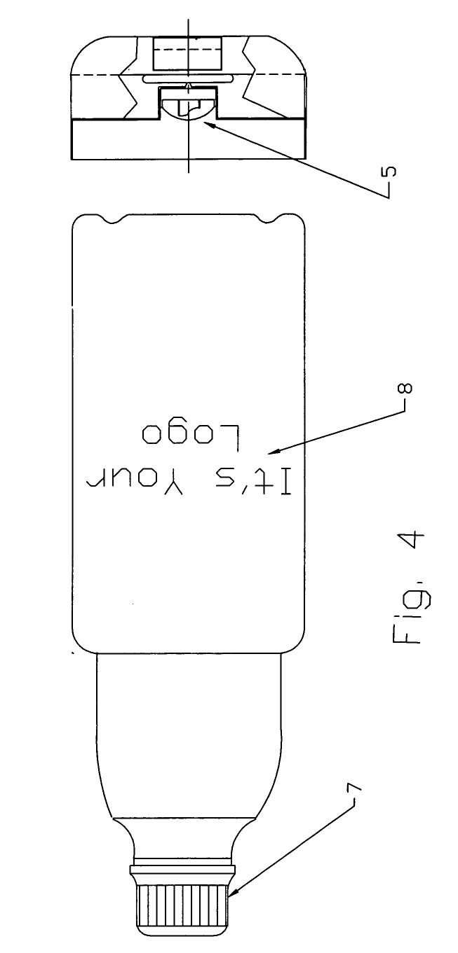

The functioning of the Liquid Illuminator (FIG. 1; Item 1) is pressed into the bottom of the poly bottle (FIG. 1; Item 2) by hand pressing it on. A lip is on the Liquid Illuminator shell to help the installation of the poly bottle (FIGS. 1 & 2; Item 10). At that time the cap (FIG. 4; Item 7) is removed and the liquid poured is poured into the poly bottle and the cap is than put back on the container. The cap on the top of the container (FIG. 4; Item 7) may be a snap on or a twist top. A dark liquid may not illuminate as brightly as a clear liquid. It is therefore recommended that a lighter color or clearer liquid be used. The cap is then replaced on the poly bottle. The liquid is then illuminated by activating the switch on the bottom of the Liquid Illuminator (FIG. 2; Item 3) by moving the switch slide outwards. At this point the switch is anchored to the slide switch (FIG. 1; Item 9). At that time the slide switch (FIGS. 1 & 3; Item 4) will move in such a manner as to create the contact between the plus and minus side of the battery (FIGS. 2 & 3; Item 5). This in turn will create the illuminating of the LED light (FIGS. 2 & 3; Item 6).

One of the main purpose of the invention is not only to illuminate a liquid in a sports or a poly drinking container, but also to give the promoter or advertiser a product to advertise their event, or place of business. This advertising is achieved by placing the logo of the business on the poly bottle as shown in (FIG. 4; Item 8). With the liquid is in the poly bottle and the LED (FIG. 4; Item 5) lit up the logo will illuminate, thereby advertising the event or business.

### DESCRIPTION OF THE DRAWINGS

1. FIG. 1 shows the view of the Liquid Illuminator in the position that it would be in before the poly bottle is slid into position. The view also shows the small lip on the end of the Liquid Illuminator cup allowing easy insertion of the poly bottle. This FIG. 1 also shows the switch in the off position, which in this position the LED light is not on.

2. FIG. 2 shows the switch in the out position turning the light on illuminating the liquid in the poly bottle. This FIG. 2 also the poly bottle in the inserted pressed in position resting just above the LED light.

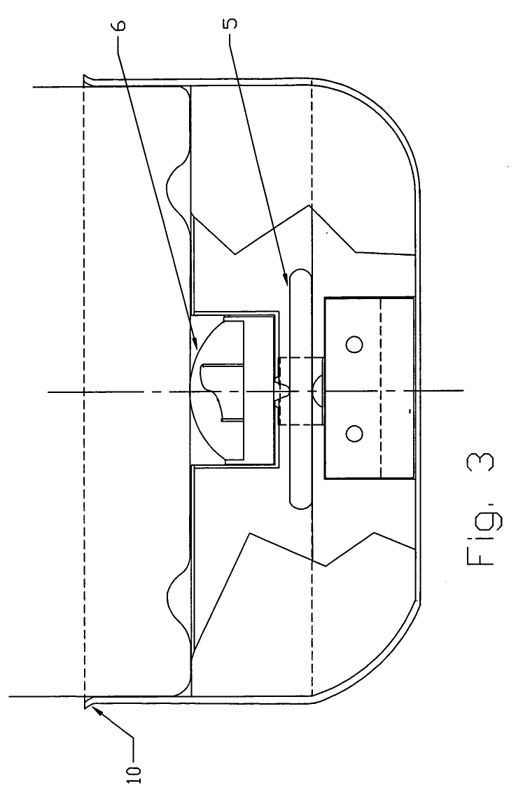

3. FIG. 3 shows the side view of the switch to indicate that it is in the center position to achieve maximum benefit of the balance of the items needed to activate the LED of the Liquid Illuminator.

4. FIG. 4 shows the poly bottle and Liquid Illuminator as they would be before insertion of the poly bottle. The main purpose of the view is to indicate where the logo would go for an event or a business advertising.

1. The only liquid illuminator on the market that can be slid into any standard sports event or advertiser poly bottle. Being so it is fabricated separate from the bottle therefore is different from other patents mentioned in the Background of the Patent.

2. The only liquid laminator that will illuminate the silk screen logo on the poly bottle's with the logo not requiring special paper or surface treatment for the logo to illuminate.

3. The only liquid illuminator that has a plastic slide as an integral part of the mechanism that is located in a position that when it is off it can be carried without any part of the slide protruding outside of the poly bottle.
